(19) United States
(12) Patent Application Publication
(10) Pub. No.: US 2018/0020252 A1
(43) Pub. Date: Jan. 18, 2018

(54) INFORMATION DISPLAY METHOD, CHANNEL MANAGEMENT PLATFORM, AND TERMINAL

(71) Applicant: Tencent Technology (Shenzhen) Company Limited, Shenzhen (CN)

(72) Inventor: Zhangjun XIONG, Shenzhen (CN)

(21) Appl. No.: 15/717,215

(22) Filed: Sep. 27, 2017

Related U.S. Application Data
(63) Continuation of application No. PCT/CN2016/074859, filed on Feb. 29, 2016.

(30) Foreign Application Priority Data
Mar. 27, 2015 (CN) 201510142787.X

(51) Int. Cl. H04N 21/2668; H04N 21/472; H04N 21/45; H04N 21/433; H04N 21/2187; H04N 21/258; H04N 21/24; H04N 21/478; H04N 21/442

(52) U.S. Cl. CPC H04N 21/2668; H04N 21/47815; H04N 21/47202; H04N 21/4532; H04N 21/44204; H04N 21/2187; H04N 21/25891; H04N 21/25875; H04N 21/2407; H04N 21/4334

(57) ABSTRACT

In some embodiments, an information display method includes: receiving an information display request and to-be-displayed information of a to-be-displayed object from a terminal corresponding to a first user; obtaining, based on the user identifier, a display channel allocated to the first user in advance; obtaining the video stream corresponding to the to-be-displayed object at the current moment from the to-be-displayed information, when detecting that the display channel corresponding to the first user is selected; sending the video stream corresponding to the to-be-displayed object at the current moment to the intelligent television; and controlling the intelligent television to broadcast the video stream corresponding to the to-be-displayed object at the current moment on the display channel corresponding to the first user.

The present application is a continuation of International Patent Application No. PCT/CN2016/074859 filed on Feb. 29, 2016, which claims the priority to Chinese Patent Application No. 201510142787.X, titled “INFORMATION DISPLAY METHOD, CHANNEL MANAGEMENT PLATFORM, AND TERMINAL”, filed on Mar. 27, 2015 with the State Intellectual Property Office of the People's Republic of China, both of which are incorporated herein by reference in their entireties.

### TECHNICAL FIELD

The present disclosure relates to the field of internet technology, and in particular to an information display method, a channel management platform and a terminal.

### BACKGROUND

With the rapid development of the internet technology, electronic commerce platforms are developed rapidly. A user, such as a merchant may issue a to-be-displayed object, such as a store or a commodity, on an electronic commerce platform, and a consumer may purchase the displayed object based on the displayed information on the electronic commerce platform. A good information display method may attract more consumers to browse and purchase the to-be-displayed object, which can bring huge profits to merchants.

A method for displaying information in the related technology is that: a user who needs to promote a to-be-displayed object submits to-be-displayed information of the to-be-displayed object to a designated electronic commerce platform, and the designated electronic commerce platform controls to display the to-be-displayed information on equipment, such as mobile phones and computers.

In research, it is found that the related technology has at least the following problems. The information display method in the related technology only supports information display on equipment, such as computers and mobile phones, which limits an application range of the information display method, thereby limiting the promotion effect of objects to be displayed.

### SUMMARY

In order to solve problems in the related technology, an information display method, a channel management platform and a terminal are provided according to embodiments of the present disclosure. Technical solutions are described as followings.

An information display method is provided in an aspect according to the present disclosure, which is applied in a channel management platform having a processor and a memory. The information display method includes:

receiving an information display request and to-be-displayed information of a to-be-displayed object from a terminal corresponding to a first user, where the information display request carries a user identifier, and the to-be-displayed information includes video streams corresponding to the to-be-displayed object at different times;

obtaining, based on the user identifier, a display channel allocated to the first user in advance, where the display channel corresponding to the first user is a display channel of the first user on an intelligent television, and different first users correspond to different display channels of the intelligent television;

obtaining the video stream corresponding to the to-be-displayed object at the current moment from the to-be-displayed information, when detecting that the display channel corresponding to the first user is selected;

sending the video stream corresponding to the to-be-displayed object at the current moment to the intelligent television; and

controlling the intelligent television to broadcast the video stream corresponding to the to-be-displayed object at the current moment on the display channel corresponding to the first user.

An information display method is provided in another aspect according to the present disclosure, which is applied in a terminal having a processor and a memory. The information display method includes:

obtaining to-be-displayed information of a to-be-displayed object, where the to-be-displayed information includes video streams corresponding to the to-be-displayed object at different times; and

sending an information display request and the to-be-displayed information to a channel management platform, such that the channel management platform obtains the video stream corresponding to the to-be-displayed object at the current moment from the to-be-displayed information when the channel management platform detects that the display channel corresponding to the first user is selected, sends the video stream corresponding to the to-be-displayed object at the current moment to the intelligent television, and controls the intelligent television to broadcast the video stream corresponding to the to-be-displayed object at the current moment on the display channel corresponding to the first user, where

the information display request carries a user identifier of the first user, the display channel corresponding to the first user is determined by the channel management platform based on the user identifier, and different first users correspond to different display channels of the intelligent television.

A channel management platform is provided in another aspect according to the present disclosure, which includes a processor and a memory. The memory stores a set of program codes, and the processor is configured to call the program codes stored in the memory to execute the following steps:

receiving an information display request and to-be-displayed information of a to-be-displayed object from a terminal corresponding to a first user, where the information display request carries a user identifier, and the to-be-displayed information includes video streams corresponding to the to-be-displayed object at different times;

obtaining, based on the user identifier, a display channel allocated to the first user in advance, where the display channel corresponding to the first user is a display channel of the first user on an intelligent television, and different first users correspond to different display channels of the intelligent television;

obtaining the video stream corresponding to the to-be-displayed object at the current moment from the to-be-displayed information, when detecting that the display channel corresponding to the first user is selected;

sending the video stream corresponding to the to-be-displayed object at the current moment to the intelligent television; and

controlling the intelligent television to broadcast the video stream corresponding to the to-be-displayed object at the current moment on the display channel corresponding to the first user.

A terminal is provided in another aspect according to the present disclosure, which includes a processor and a memory. The memory stores a set of program codes, and the processor is configured to call the program codes stored in the memory to execute the following operations:

obtaining to-be-displayed information of a to-be-displayed object, where the to-be-displayed information includes video streams corresponding to the to-be-displayed object at different times; and

sending an information display request and the to-be-displayed information to a channel management platform, such that the channel management platform obtains the video stream corresponding to the to-be-displayed object at the current moment from the to-be-displayed information when the channel management platform detects that the display channel corresponding to the first user is selected, sends the video stream corresponding to the to-be-displayed object at the current moment to the intelligent television, and controls the intelligent television to broadcast the video stream corresponding to the to-be-displayed object at the current moment on the display channel corresponding to the first user; where

the information display request carries a user identifier of the first user, the display channel corresponding to the first user is determined by the channel management platform based on the user identifier, and different first users correspond to different display channels of the intelligent television.

The technical solutions according to the embodiments of the present disclosure bring the following beneficial effects.

A method for displaying to-be-displayed information of a to-be-displayed object corresponding to a first user on an intelligent television is provided, by controlling the intelligent television to display the to-be-displayed information of the to-be-displayed object on a display channel corresponding to the first user, which extends an application range of the information display method. In addition, since different first users correspond to different display channels of an intelligent television, a first user can display information on a display channel corresponding to the first user as desired, thereby, enhancing the promotion effect of the to-be-displayed object.

### BRIEF DESCRIPTION OF THE DRAWINGS

To illustrate technical solutions according to embodiments of the present disclosure more clearly, drawings to be used in the descriptions of the embodiments are described briefly hereinafter. The drawings described hereinafter illustrate some embodiments of the present disclosure, and other drawings may be obtained by those skilled in the art based on the described drawings.

FIG. 1 is a schematic diagram of implementation environment involved in an information display method according to an embodiment of the present disclosure;

FIG. 2 is a flow chart of an information display method according to an embodiment of the present disclosure;

FIG. 3 is a flow chart of an information display method according to an embodiment of the present disclosure;

FIG. 4 is a flow chart of an information display method according to an embodiment of the present disclosure;

FIG. 5 is a schematic structural diagram of a channel management platform according to an embodiment of the present disclosure;

FIG. 6 is a schematic structural diagram of a channel management platform according to an embodiment of the present disclosure;

FIG. 7 is a schematic structural diagram of a terminal according to an embodiment of the present disclosure;

FIG. 8 is a schematic structural diagram of a terminal according to an embodiment of the present disclosure;

FIG. 9 is a schematic diagram of an information display system according to an embodiment of the present disclosure;

FIG. 10 is a schematic diagram of a channel management platform according to an embodiment of the present disclosure; and

FIG. 11 is a schematic diagram of a channel management platform according to an embodiment of the present disclosure.

### DETAILED DESCRIPTION OF THE EMBODIMENTS

In order to make the object, technical solutions and advantages clearer, hereinafter embodiments of the present disclosure will be further described in detail in conjunction with drawings.

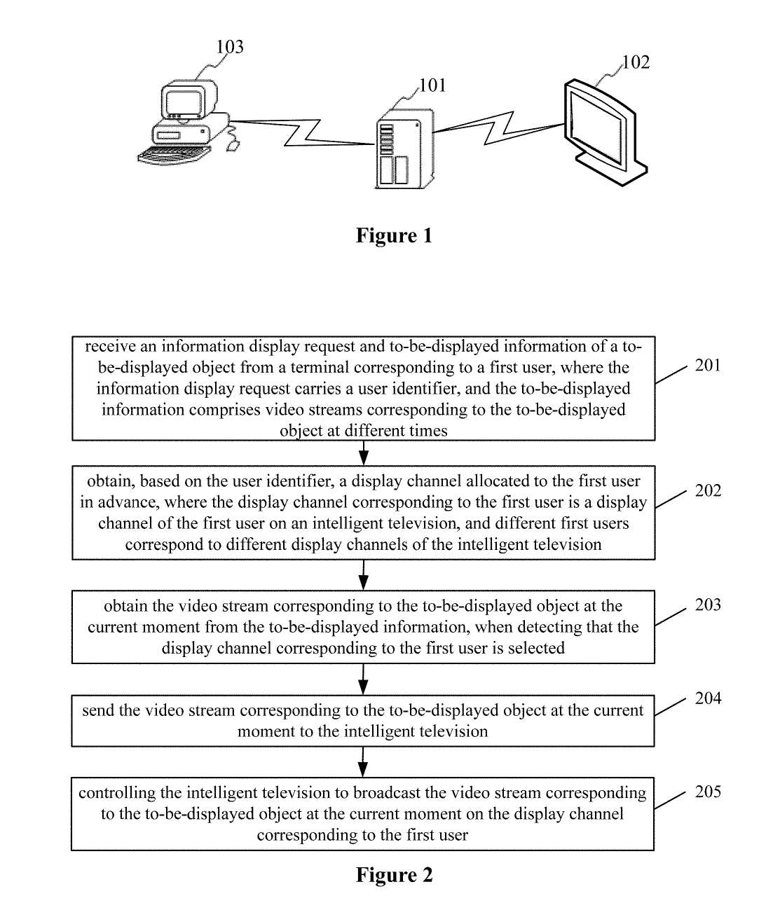

FIG. 1 is a schematic diagram of implementation environment involved in an information display method according to an embodiment of the present disclosure. As shown in FIG. 1, the implementation environment includes at least a channel management platform 101, an intelligent television 102 and a terminal 103. The channel management platform 101 may be a device independent of the intelligent television 102, such as a single server or a set-top box. Alternatively, the channel management platform 101 may also be a device loaded on the intelligent television 102, such as an application downloaded to the intelligent television 102. It should be noted that, FIG. 1 only illustrates an example that the channel management platform 101 is a device independent of the intelligent television 102. The terminal 103 is a terminal corresponds to a first user, namely, a terminal used by the first user. The first user is a user who needs to display information on the intelligent television 102, such as a merchant who needs to promote a product or a service on the intelligent television 102.

The terminal 103 is connected to the channel management platform 101 over a network. In a case that the channel management platform 101 is a device independent of the intelligent television 102, the channel management platform 101 may also be connected to the intelligent television 102 over a network. In a case that the channel management platform 101 is a device loaded on the intelligent television 102, the channel management platform 101 may perform data and instruction interaction with the intelligent television 102 via an interface. The network involved in the embodiments of the present disclosure may be a wired or wireless network.

In the embodiments of the present disclosure, the channel management platform 101 may allocate a display channel for each first user and manage the process of displaying a commodity on a corresponding display channel by the first user. The first user may send the to-be-displayed information of a corresponding to-be-displayed object to the channel management platform 101 by a corresponding terminal 103, and the channel management platform 101 controls the intelligent television 102 to display the to-be-displayed information of the to-be-displayed object on the display channel corresponding to the first user. The display channel may be a broadcast channel of the intelligent television 102.

The channel management platform 101 may be configured as a server for channel management. The terminal 103 corresponding to the first user may be a desktop computer, an intelligent phone, a tablet computer, an e-book reader, an MP3 (Moving Picture Experts Group Audio Layer III) player, an MP4 (Moving Picture Experts Group Audio Layer IV) player, a laptop portable computer and a wearable intelligent device, such as an intelligent wristband.

The detailed information display method is described in the following embodiments.

FIG. 2 is a flow chart of an information display method according to an embodiment of the present disclosure. A channel management platform implements the method according to the embodiment of the present disclosure, for example. Referring to FIG. 2, the method according to the embodiment of the present disclosure includes steps 201 to 205.

In step 201, an information display request and to-be-displayed information of a to-be-displayed object are received from a terminal corresponding to a first user. The information display request carries a user identifier. The to-be-displayed information includes video streams corresponding to the to-be-displayed object at different times.

In step 202, a display channel allocated to the first user in advance is obtained based on a user identifier. The display channel corresponding to the first user is a display channel of the first user on an intelligent television, and different first users correspond to different display channels of the intelligent television.

In step 203, the video stream corresponding to the to-be-displayed object at the current moment is obtained from the to-be-displayed information, when detecting that the display channel corresponding to the first user is selected.

In step 204, the video stream corresponding to the to-be-displayed object at the current moment to the intelligent television is sent to the intelligent television.

In step 205, the intelligent television is controlled to broadcast the video stream corresponding to the to-be-displayed object at the current moment on the display channel corresponding to the first user.

In another embodiment, after receiving the information display request and the to-be-displayed information of the to-be-displayed object from the terminal corresponding to the first user, the method further includes:

determining a category of the display channel corresponding to the first user based on the to-be-displayed information; and

controlling the intelligent television to display the display channel corresponding to the first user under a corresponding category on a channel display page, when detecting that the intelligent television displays the channel display page, where

the channel display page includes at least a pre-set display channel category.

In another embodiment, the method further includes:

counting the number of access times of each managed display channel;

determining a popular display channel based on the number of access times of each display channel; and

controlling the intelligent television to display the popular display channel on a designated region of an information recommendation page, when detecting that the intelligent television displays the information recommendation page.

In another embodiment, the method further includes:

obtaining a history record of each display channel being watched by a second user on the intelligent television;

determining a display channel of interest to the second user, based on the history record of each display channel being watched by the second user on the intelligent television; and

pushing other display channels related to the content of the display channel of interest to the second user to the second user, when detecting that the second user enters into a channel display page including multiple display channels on the intelligent television.

In another embodiment, after receiving the information display request and the to-be-displayed information of the to-be-displayed object from the terminal corresponding to the first user, the method further includes:

receiving a shopping platform association request from the terminal corresponding to the first user;

sending an identifier of a bounded shopping platform to the terminal corresponding to the first user in response to the shopping platform association request, such that the first user associates the to-be-displayed information with a target shopping platform from the bounded shopping platform, based on the identifier of the bounded shopping platform.

In another embodiment, after controlling the intelligent television to broadcast the video stream corresponding to the to-be-displayed object at the current moment on the display channel corresponding to the first user, the method further includes:

detecting target to-be-displayed information which is selected by the second user from the display channel corresponding to the first user, where the target to-be-displayed information is associated with a designated page of the target shopping platform, and the target shopping platform is one of the bounded shopping platform; and

controlling the intelligent television to turn to the designated page and display information on the designated page, when detecting that the second user selects the target shopping platform with which the target to-be-displayed information is associated.

Any combinations of all the above optional technical solutions may be used to form an optional embodiment of the present disclosure, which are not repeated herein.

With the method according to the embodiment of the present disclosure, a method for displaying to-be-displayed information of a to-be-displayed object corresponding to a first user on an intelligent television is provided by controlling the intelligent television to display the to-be-displayed information of the to-be-displayed object on a display channel corresponding to the first user, which extends an application range of the information display method. In addition, since different first users correspond to different display channels of an intelligent television, a first user can display information on a display channel corresponding to the first user as desired, thereby, enhancing the promotion effect of the to-be-displayed object.

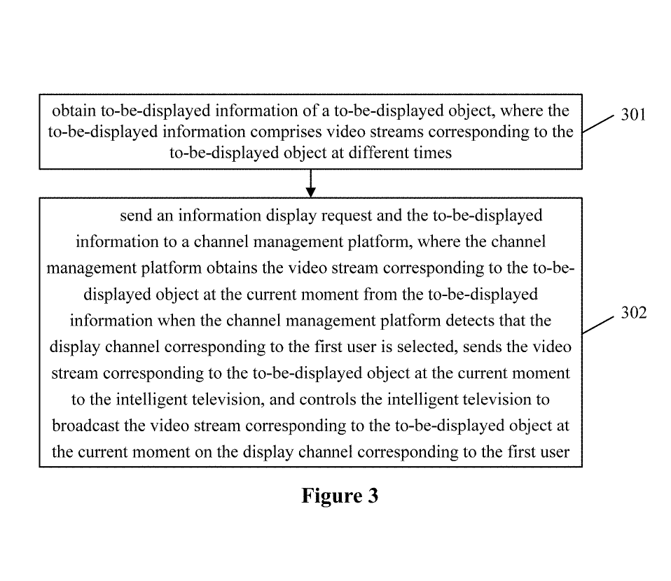

FIG. 3 is a flow chart of an information display method according to an embodiment of the present disclosure. That a terminal corresponding to a first user implements the method according to the embodiment of the present disclosure is taken as example. Reference is made to FIG. 3. The method according to the embodiment of the present disclosure includes steps 301 to 302.

In step 301, to-be-displayed information of a to-be-displayed object is obtained. The to-be-displayed information includes video streams corresponding to the to-be-displayed object at different times.

In step 302, an information display request and the to-be-displayed information are sent to a channel management platform, so that the channel management platform obtains the video stream corresponding to the to-be-displayed object at the current moment from the to-be-displayed information when the channel management platform detects that the display channel corresponding to the first user is selected, sends the video stream corresponding to the to-be-displayed object at the current moment to the intelligent television, and controls the intelligent television to broadcast the video stream corresponding to the to-be-displayed object at the current moment on the display channel corresponding to the first user.

The information display request carries a user identifier of the first user, the display channel corresponding to the first user is determined by the channel management platform based on the user identifier, and different first users correspond to different display channels of the intelligent television.

In another embodiment, after sending the information display request and the to-be-displayed information to the channel management platform, the method further includes:

sending a shopping platform association request to the channel management platform;

receiving, from the channel management platform, an identifier of a shopping platform bounded to the channel management platform;

selecting a target shopping platform from the bounded shopping platform based on the identifier of the bounded shopping platform; and

associating the to-be-displayed information to the target shopping platform.

In another embodiment, the associating the to-be-displayed information to the target shopping platform includes:

establishing a mapping relation between the to-be-displayed information and detail information of the to-be-displayed object on the target shopping platform; or

establishing a mapping relation between the to-be-displayed information and a link address of the to-be-displayed object on the target shopping platform.

In another embodiment, the obtaining the to-be-displayed information of the to-be-displayed object includes:

obtaining a display file of the to-be-displayed object;

generating a channel timeline of the display files based on a broadcast time arranged by the first user in advance for each display file, where the channel timeline is used to identify the broadcast time of each display file; and

generating the video streams corresponding to the to-be-displayed object at different times according to the channel timeline and determining the video streams corresponding to the to-be-displayed object at different times as the to-be-displayed information of the to-be-displayed object.

In another embodiment, before obtaining the to-be-displayed information of the to-be-displayed object, the method includes:

receiving a processing procedure watching request of the to-be-displayed object from a terminal corresponding to a second user;

the obtaining the to-be-displayed information of the to-be-displayed object includes:
recording a live video of the to-be-displayed object in response to the processing procedure watching request, wherein the live video is a video showing that the first user processes the to-be-displayed object; and
generating a video stream of the live video based on the live video and the current moment, and determining the video stream of the live video as the to-be-displayed information of the to-be-displayed object; and

the sending the information display request and the to-be-displayed information to the channel management platform includes:
sending the information display request and the video stream of the live video generated in a real-time manner to the channel management platform.

Any combinations of all the above optional technical solutions may be used to form an optional embodiment of the present disclosure, which are not repeated herein.

With the method according to the embodiment of the present disclosure, an information display request and to-be-displayed information of a to-be-displayed object are sent to a channel management platform, so that the channel management platform controls an intelligent television to display the to-be-displayed information of the to-be-displayed object on a display channel corresponding to the first user. Therefore, a method for displaying to-be-displayed information of a to-be-displayed object corresponding to a first user on an intelligent television is provided, which extends an application range of the information display method. In addition, since different first users correspond to different display channels of an intelligent television, a first user can display information on a display channel corresponding to the first user as desired, thereby, enhancing the promotion effect of the to-be-displayed object.

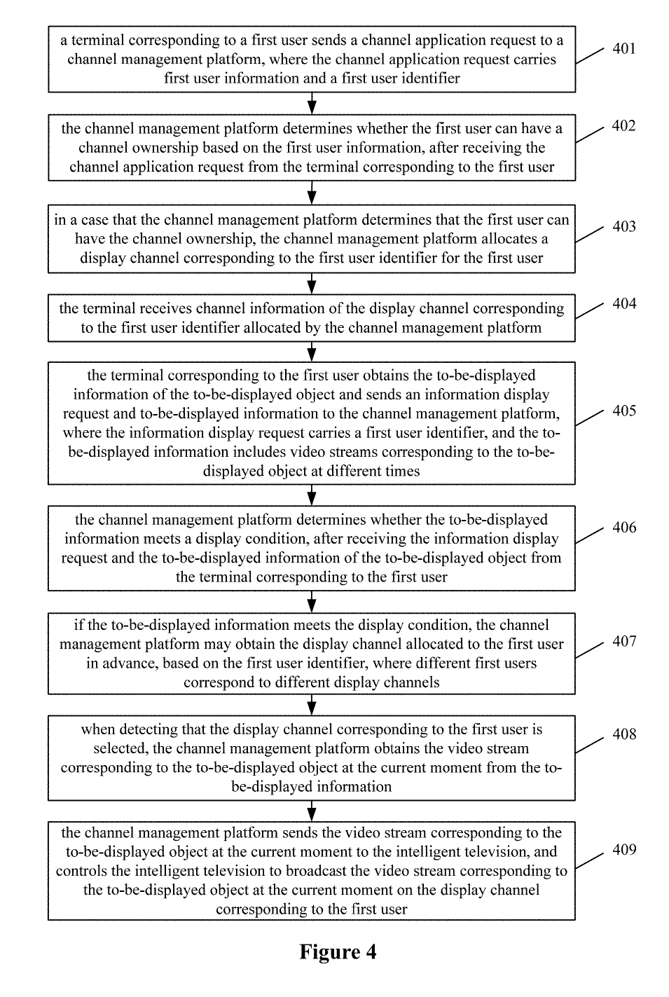

FIG. 4 is a flow chart of an information display method according to an embodiment of the present disclosure. The method according to the embodiment of the present disclosure is implemented via an interaction between a channel management platform and a terminal. Reference is made to FIG. 4. The method according to the embodiment of the present disclosure includes steps 401 to 409.

In step 401, a terminal corresponding to a first user sends a channel application request to a channel management platform, where the channel application request carries first user information and a first user identifier.

With the method according to the embodiment of the present disclosure, to-be-displayed information of a to-be-displayed object corresponding to a first user is displayed on a display channel on an intelligent television, and different first users may display the to-be-displayed information of the to-be-displayed object on display channels corresponding to the first users. In order to display to-be-displayed information on a corresponding display channel, each of the first users should apply to the channel management platform for a display channel in advance through a terminal used by the first user. The step 401 is a triggering step of applying to the channel management platform for the display channel by the first user, that is, when the first user applies to the channel management platform for the display channel, the application is triggered by the corresponding terminal by sending the channel application request to the channel management platform.

To facilitate the channel management platform determining whether to allocate a display channel for the first user, the channel application request carries the first user information. The first user information can identify a category and an attribute of the to-be-displayed object which needs to be displayed by the first user. The first user information may further include a store name of the first user, a credit line of the first user and a customer score, etc. In addition, to facilitate the channel management platform distinguishing each of the first users, the channel application request further carries the first user identifier. The first user identifier is a global unique identifier to distinguish the first user from other users, which may be an account or a phone number of the first user, but is not limited in the embodiment of the present disclosure.

There may be a variety of ways for a terminal to send a channel application request to a channel management platform. For example, a channel management platform may provide a channel application page, and the channel application page includes a channel application option. When detecting that the channel application option is selected, the terminal triggers to send the channel application request to the channel management platform. The detecting whether the channel application option is selected by the terminal may be implemented by detecting operations, such as a double click or a long press on the channel application option. Specifically, if the channel application option is double-clicked or long-pressed, the terminal may determine that the channel application option is selected.

In step 402, the channel management platform determines whether to allow the first user to have a channel ownership based on the first user information, after receiving the channel application request from the terminal corresponding to the first user.

To maintain a good channel management, the channel management platform needs to examine the first user, when determining whether to allocate the display channel for the first user. Only a user passing the examination can have the channel ownership. To determine whether to allocate the display channel for the first user, the channel management platform needs to determine whether to allow the first user to have the channel ownership based on the first user information.

The channel management platform may determine whether to allow the first user to have the channel ownership based on specific content of the first user information. For example, whether an object required to be displayed by a first user is valid may be determined according to the category and the attribute of the to-be-displayed object in the first user information, and a first user whose to-be-displayed object is valid can have the channel ownership. The channel management platform may pre-determine valid categories and attributes for to-be-displayed objects, and may determine whether the to-be-displayed object is valid by determining whether a category of the to-be-displayed object is one of the pre-set valid categories, or by determining whether an attribute of the to-be-displayed object is one of the valid attributes.

In addition, whether a customer score of a first user is greater than a pre-set threshold may be further determined. If the customer score is greater than the pre-set threshold, it is determined that the first user can have the channel ownership. A numerical range of the pre-set threshold is not limited in the embodiment of the present disclosure. For example, if the full customer score is 5, the pre-set threshold may be 4.0 or 4.5, etc.

Alternatively, the channel management platform may determine whether the first user can have the channel ownership based on a combination of the specific contents included in the first user information. Specifically, it is determined that the first user can have the channel ownership if all information included in the to-be-displayed information meets a pre-set condition. In addition, whether the first user can have the channel ownership may also be determined manually by manually examining the first user information of the first user. The manners of determining whether the first user can have the channel ownership by the channel management platform are not limited in the embodiment of the present disclosure.

In step 403, in a case that the channel management platform determines that the first user can have the channel ownership, the channel management platform allocates a display channel corresponding to the first user identifier for the first user.

To facilitate the first user displaying the to-be-displayed information, the channel management platform in the embodiment of the present disclosure allocates different display channels for different first users. To distinguish different display channels of the first users, after determining that the first user can have the channel ownership, the channel management platform allocates a display channel corresponding to the first user identifier for the first user. That is, in allocating a display channel for each of the first users, the channel management platform may establish a mapping relation between the first user identifier and the display channel.

The channel management platform may allocate the display channel corresponding to the first user identifier for the first user based on the first user information. For example, the channel management platform may pre-set display channels corresponding to various categories of the to-be-displayed object, and after determining a category of the to-be-displayed object of the first user, the channel management platform selects a display channel from display channels corresponding to the category randomly or in an application order as the display channel of the first user.

After the channel management platform allocates a display channels for the first users, the mapping relation between a first user identifier of each of the first users and a corresponding display channel may be obtained. As shown in Table 1, Table 1 illustrates the mapping relation between first user identifiers and display channels.

TABLE 1

| first user identifier | display channel |
|---|---|
| first user A | display channel A |
| . . . | . . . |
| first user B | display channel B |

Data in Table 1 is only taken as an example, which is not to be construed as limiting the embodiment of the present disclosure.

Optionally, since the number of the first users is large, after allocating display channels for the first users, in displaying a channel display page including at least display channels of all the first users on an intelligent television, many display channels need to be displayed on the channel display page. To facilitate the channel management platform managing the display channels of the intelligent television, the display channels may be classified to be displayed. For example, the pre-set categories of the display channels may be displayed on the channel display page, and the display channels are displayed under corresponding categories. Therefore, after allocating a display channel corresponding to a first user identifier for the first user, the channel management platform may determine a category of the display channel corresponding to the first user based on the to-be-displayed information of the first user, and may control an intelligent television to display the display channel corresponding to the first user under a corresponding category on the channel display page, when the intelligent television displays the channel display page. That is, the channel management platform sends channel information of the display channel corresponding to the first user and the category of the display channel to the intelligent television, to control the intelligent television to display the display channel corresponding to the first user under the corresponding category on the channel display page when the intelligent television displays the channel display page.

For example, a category A, a category B, and a category C may be displayed on the channel display page. If a category of a display channel corresponding to a first user A is the category B, the display channel corresponding to the first user A is displayed under the category B. That is, when detecting that the category B is selected, all display channels under the category B may be displayed. The display channel corresponding to the first user A is one of the display channels under the category B.

In step 404, the terminal receives channel information of the display channel corresponding to the first user identifier allocated by the channel management platform.

After the channel management platform allocates the display channel for the first user, the terminal receives the channel information of the display channel corresponding to the first user identifier allocated by the channel management platform. In this case, the first user may determine the allocated display channels based on the channel information, and may display the to-be-displayed information of the to-be-displayed object on a corresponding channel according to requirements of the first user. The channel information includes, but not limited to, an identifier and a name of the display channel.

Optionally, with the rapid development of the electronic commerce technology, to promote a to-be-displayed object of a first user, the first user generally has corresponding shops on various shopping platforms, and displays to-be-displayed information of the to-be-displayed object on the shops. In view of this, in order to extend a range of information display and to facilitate a second user obtaining more to-be-displayed information, the channel management platform may establish cooperation relations with various shopping platforms. On this basis, the first user may associate to-be-displayed information with a target shopping platform via the channel management platform. In this case, when browsing to-be-displayed information of a to-be-displayed object on a display channel which is associated with a target shopping platform, the second user may further turn from the channel management platform to the target shopping platform to learn more information of the to-be-displayed object from the target shopping platform, or further complete an transaction of the to-be-displayed object via the target shopping platform. The target shopping platform is associated with the to-be-displayed information.

Based on the above content, after receiving the display channel corresponding to the first user identifier allocated by the channel management platform, the terminal may further associate the to-be-displayed information with a target shopping platform. The associating the to-be-displayed information to a target shopping platform by the terminal includes, but not limited to, the following step 1 to step 4.

In step 1, a terminal corresponding to a first user sends a shopping platform association request to a channel management platform.

The associating the to-be-displayed information to the target shopping platform by the terminal corresponding to the first user is triggered by sending the shopping platform association request to the channel management platform. The sending the shopping platform association request by the terminal corresponding to the first user to the channel management platform includes, but not limited to: displaying a shopping platform association option on the terminal, and triggering the terminal to send the shopping platform association request to the channel management platform after the shopping platform association option is selected.

In step 2, the channel management platform sends an identifier of a bounded shopping platform to the terminal corresponding to the first user in response to the shopping platform association request, after receiving the shopping platform association request sent by the terminal corresponding to the first user.

The bounded shopping platform is a shopping platform which has established cooperation relation with the channel management platform. In order to facilitate the first user selecting one or more of the bounded shopping platforms as a target shopping platform, the channel management platform may send the identifier of the bounded shopping platform to the terminal corresponding to the first user, in response to the shopping platform association request. The identifier of the bounded shopping platform includes, but not limited to, a name of the bounded shopping platform, a URL (Uniform Resource Locator), or others which ensures a shopping platform to be distinguished from other shopping platforms.

In step 3, the terminal corresponding to the first user selects a target shopping platform from the bounded shopping platform based on the identifier of the bounded shopping platform, after receiving the identifier of the bounded shopping platform returned by the channel management platform.

After receiving the identifier of the shopping platform bounded to the channel management platform, which is returned by the channel management platform, the terminal corresponding to the first user may display the identifier of the bounded shopping platform bounded with the channel management platform. Specifically, the terminal corresponding to the first user may display the identifiers of the bounded shopping platforms in a list.

Further, the first user may select one or more of the shopping platforms bounded with the channel management platform as a target shopping platform, based on the displayed identifier of the bounded shopping platform. Specifically, after the first user selects some of the bounded shopping platforms, the terminal determines the shopping platforms selected by the first user as target shopping platforms.

In step 4, the terminal associates the to-be-displayed information with the target shopping platform.

Specifically, the channel management platform may pre-set an interface between a display channel and a target shopping platform. When associating the to-be-displayed information to the target shopping platform, the terminal may establish an association relation between the display channel and the target shopping platform via the interface, to ensure user to turn from the display channel to the target shopping platform. The associating the to-be-displayed information to the target shopping platform by the terminal includes, but not limited to, the following two manners.

In a first manner, the terminal corresponding to the first user establishes a mapping relation between to-be-displayed information and detail information of the to-be-displayed object on the target shopping platform.

Specifically, when the to-be-displayed information is associated with the target shopping platform in this manner, a second user may directly turn from a display channel of the first user to a page showing the detail information of the to-be-displayed object on the target shopping platform, and may learn about the to-be-displayed object based on the detail information displayed on the page. Therefore, the associating the to-be-displayed information to the target shopping platform in this manner may simplify operations of the second user, thereby, bringing the good operation experience to the second user.

That is, when browsing the to-be-displayed information of the to-be-displayed object on a display channel, the second user may trigger an association information display operation on an intelligent television, and the intelligent television may send an association information display request to the channel management platform. The channel management platform obtains the detail information of the to-be-displayed information based on the established mapping relation and controls the intelligent television to display the detail information.

In a second manner, the terminal corresponding to the first user establishes a mapping relation between the to-be-displayed information and a link address of the to-be-displayed object on the target shopping platform.

The link address is used to link to a page of the to-be-displayed object on the target shopping platform, or may be configured to display a page of the to-be-displayed information of the to-be-displayed object, such as a page of commodity details, or may also be a page showing multiple other to-be-displayed objects associated with the to-be-displayed object, such as a home page of a shop of a commodity.

Specifically, the second user may turn from the display channel of the first user to the page of the to-be-displayed object, by associating the to-be-displayed information to the target shopping platform in this manner. Since the page of the to-be-displayed object generally includes abundant content, users can fully learn about commodities conveniently.

That is, when browsing the to-be-displayed information of the to-be-displayed object on a display channel, the second user may trigger an association information display operation on an intelligent television, and the intelligent television may send an association information display request to the channel management platform. The channel management platform obtains a link address corresponding to the to-be-displayed information based on the established mapping relation and sends the link address to the intelligent television to control the intelligent television to display the page of the to-be-displayed object based on the link address.

It should be noted that, step 401 to step 404 are specific implementations of allocating a corresponding display channel for a first user by the channel management platform. Based on step 401 to step 404, each of the first users may obtain one display channel corresponding to a first user identifier, and may display the to-be-displayed information on the corresponding display channel of an intelligent television. However, step 401 to step 404 do not need to be executed every time when executing the information display method, as long as when a first user is to display the to-be-displayed information, the channel management platform has allocated a display channel to the first user.

In step 405, the terminal corresponding to the first user obtains the to-be-displayed information of the to-be-displayed object and sends an information display request and to-be-displayed information to the channel management platform. The information display request carries a first user identifier, and the to-be-displayed information includes video streams corresponding to the to-be-displayed object at different times.

After the channel management platform allocates a display channel corresponding to the first user identifier for the first user, the first user may send the to-be-displayed information of the to-be-displayed object to the channel management platform via a terminal used by the first user, and the channel management platform controls the display of the to-be-displayed information on the display channel of the intelligent television. Specifically, to display the to-be-displayed information as desired by the first user, the to-be-displayed information of the to-be-displayed object should be first obtained, and the display is triggered by sending the information display request and to-be-displayed information to the channel management platform. Further, to facilitate the channel management platform determining which one of the display channels is configured to broadcast the to-be-displayed information, the information display request carries the first user identifier.

In the embodiment of the present disclosure, after allocating the display channel of the intelligent television, the first user may arrange broadcast content and a playing order of the to-be-displayed object on the intelligent television according to requirements of the first user. To control the intelligent television to broadcast a video according to requirements of the first user at different times, the to-be-displayed information which is obtained by the first user includes video streams corresponding to the to-be-displayed object at different times.

Specifically, the obtaining the to-be-displayed information of the to-be-displayed object by the terminal includes, but not limited to, the following step 1 to step 3.

In step 1, a terminal obtains a display file of a to-be-displayed object.

The display file of a to-be-displayed object may be at least one of a video of the to-be-displayed object, a live video stream of the to-be-displayed object, or a target shopping platform with which the to-be-displayed object is associated. Specifically, in displaying the to-be-displayed information of the to-be-displayed object, the first user needs to determine display content for each to-be-displayed object. For example, for a to-be-displayed object, the first user may capture a video of the to-be-displayed object, make an advertisement of the to-be-displayed object, or provide a target platform with which the to-be-displayed object is associated. In the embodiment of the present disclosure, the files related to the to-be-displayed object are regarded as the display files of the to-be-displayed object.

Specifically, a terminal may provide an import interface of the display file. To obtain the display file of the to-be-displayed object, files imported from the import interface are regarded as the display files of the to-be-displayed object.

In step 2, a terminal corresponding to the first user generates a channel timeline of the display files, based on a broadcast time arranged by the first user in advance for each display file. The channel timeline is used to identify the broadcast time of each display file.

Since each of the first users may flexibly display the to-be-displayed information on a display channel corresponding to an intelligent television, the first user may flexibly arrange a broadcast time for each display file. Further, the first user arranges the broadcast time in advance for each display file. Therefore, the terminal may obtain the to-be-displayed information, according to the channel timeline of the display files generated by the first user according to the broadcast time arranged in advance for each display file. On this basis, the intelligent television may broadcast the display files according to the channel timeline, when the to-be-displayed information of the to-be-displayed object is displayed on the intelligent television subsequently.

For example, if a channel timeline of display files of a to-be-displayed object is to first broadcast a video A and then broadcast a video B, a channel timeline of to-be-displayed information of the to-be-displayed object is to: first broadcast the video A, then broadcast the video B, and finally broadcast a live stream of a live show.

In step 3, the terminal corresponding to the first user generates video streams corresponding to the to-be-displayed object at different times according to the channel timeline and determines the video streams corresponding to the to-be-displayed object at different times as the to-be-displayed information of the to-be-displayed object.

A video stream should be generated to display the information on an intelligent television. In the embodiment of the present disclosure, in order to display to-be-displayed information of the to-be-displayed object on an intelligent television, the terminal corresponding to the first user should generate the video streams corresponding to the to-be-displayed object at different times according to the channel timeline. Manners of generating the video streams are not described in the embodiment of the disclosure.

In step 406, the channel management platform determines whether the to-be-displayed information meets a display condition, after receiving the information display request and the to-be-displayed information of the to-be-displayed object from the terminal corresponding to the first user.

This step is an optional step. After receiving the to-be-displayed information, the channel management platform may directly display the to-be-displayed information on a display channel corresponding to the first user identifier on the intelligent television. Moreover, in order to maintain the order of the display channels, the channel management platform may ensure that the displayed information should be healthy and positive. Therefore, after receiving the to-be-displayed information, the channel management platform should determine whether the to-be-displayed information meets the display condition.

Features of to-be-displayed information which does not meet the display condition may be stored in advance, and when determining whether the to-be-displayed information meets the display condition, the features of the to-be-displayed information are extracted and compared with the features of to-be-displayed information which does not meets the display condition. In a case that a similarity between the features of the to-be-displayed information and the features of to-be-displayed information which does not meets the display condition reaches a designated threshold, it is determined that the to-be-displayed information does not meet the display condition; and in a case that the similarity between the features of the to-be-displayed information and the features of to-be-displayed information which does not meets the display condition does not reach the designated threshold, it is determined that the to-be-displayed information meets the display condition. A specific numerical range of the designated threshold is not limited in the embodiment of the present disclosure. For example, the designated threshold may be 70% or 80%, etc.

In addition, whether the to-be-displayed information meets the display condition may be determined by a specialized censor for the to-be-displayed information. The manners of determining whether the to-be-displayed information meets the display condition by the channel management platform are not limited by the embodiment of the present disclosure.

In step 407, if the to-be-displayed information meets the display condition, the channel management platform may obtain the display channel allocated to the first user in advance, based on the first user identifier. Different first users correspond to different display channels.

In the embodiment of the present disclosure, to facilitate each of the first users to display corresponding display information on a corresponding display channel, the channel management platform can allocate different display channels for different first users. For example, the channel management platform may allocate a display channel to a first user. In order to determine which one of the display channels of the intelligent television is configured to display the received to-be-displayed information, the channel management platform should obtain the display channel allocated to the first user in advance, based on the first user identifier.

In obtaining the display channel allocated to the first user in advance, based on the first user identifier, the channel management platform may match the first user identifier in a pre-established mapping relation between the first user identifiers and the display channels. A display channel corresponding to the first user identifier in the mapping relation is regarded as the obtained display channel corresponding to the first user.

In step 408, when detecting that the display channel corresponding to the first user is selected, the channel management platform obtains the video stream corresponding to the to-be-displayed object at the current moment from the to-be-displayed information.

Specifically, in order to ensure that content broadcasted by an intelligent television corresponds to the video stream generated by a terminal corresponding to a first user, the channel management platform obtains the video stream corresponding to the to-be-displayed object at the current moment from the to-be-displayed information, when controlling the intelligent television to broadcast the to-be-displayed information. The channel management platform may obtain the video stream corresponding to the to-be-displayed object at the current moment from the to-be-displayed information by receiving video streams generated by a first terminal in a real-time manner.

In addition, the channel management platform may detect whether the display channel corresponding to the first user is selected by detecting whether an access request of the display channel corresponding to the first user is received. If the access request of the display channel corresponding to the first user is received, it is determined that the display channel corresponding to the first user is selected.

In step 409, the channel management platform sends the video stream corresponding to the to-be-displayed object at the current moment to the intelligent television; and controls the intelligent television to broadcast the video stream corresponding to the to-be-displayed object at the current moment on the display channel corresponding to the first user.

A method of sending the video stream corresponding to the to-be-displayed object at the current moment to the intelligent television by the channel management platform is not limited in the embodiment of the present disclosure.

In addition, the controlling, by the channel management platform, the intelligent television to broadcast the video stream corresponding to the to-be-displayed object at the current moment on the display channel corresponding to the first user may be triggered by sending broadcast instructions to the intelligent television. The intelligent television broadcasts the video stream corresponding to the to-be-displayed object at the current moment on the display channel corresponding to the first user, in response to the broadcast instructions. The triggering time when the channel management platform sends the broadcast instructions to the intelligent television includes, but not limited to, the time when detecting that the second user switches to the display channel corresponding to the first user.

Optionally, in managing the display channels corresponding to the first users by a channel management platform, if some display channels are determined to be popular in users, the channel management platform may mainly display those display channels. In the embodiment of the present disclosure, the display channel popular in users is defined as a hot display channel. A hot display channel should be determined firstly if the popular display channel is to be displayed. Specifically, the number of access times of each managed display channel may be counted, and the popular display channel is determined according to the number of access times of each display channel. After determining the popular display channel, when displaying an information recommendation page, the intelligent television displays the popular display channel on a designated region of the information recommendation page. The recommendation page is a page displaying the popular display channel. The recommendation page may be included in a channel display page, or an individual page on the intelligent television, or may also be a region in a display channel. A specific position of the designated region is not limited in the embodiment of the present disclosure. For example, the designated region may be an upper region, a middle region or a lower region of a commendation page.

Specifically, in counting the number of access times of each display channel by the channel management platform, the number of access times of a display channel is increased by one each time when detecting a user access to the display channel. This step is executed for each of the display channels, to obtain the number of access times of each display channel.

Optionally, when browsing the to-be-displayed information of the to-be-displayed object which is displayed on an intelligent television on a display channel, a user tends to select a to-be-displayed object of interest, and may switch between multiple display channels displaying the to-be-displayed objects of interest. In order to better recommend the to-be-displayed object of interest to the user, the channel management platform may recommend multiple display channels related to the to-be-displayed object of interest to the user. The recommending multiple display channels related to the to-be-displayed object of interest to the user includes, but not limited to the following steps.

In a first step, a history record of each display channel being watched by a second user on the intelligent television is obtained.

A display channel and corresponding to-be-displayed information watched by the second user is recorded each time when the second user watches the display channel. For example, the history record of each display channel being watched by the second user on the intelligent television may be obtained, based on a history browse record of the second user, or based on a history purchase record of the second user.

In a second step, a display channel of interest to the second user is determined based on the history record of each display channel being watched by the second user on the intelligent television.

Specifically, if the second user frequently browses to-be-displayed information of a type of to-be-displayed object in the history record, or frequently purchases a type of to-be-displayed object, it may be determined that the second user pays close attention to this type of to-be-displayed object. Therefore, the display channel of interest to the second user may be determined based on the history record of each display channel being watched by the second user on the intelligent television.

The display channel of interest to the second user may be a display channel of the to-be-displayed object which is of interest to the second user, or may also be the display channel of a to-be-displayed object having the same type as the to-be-displayed object of interest to the second user.

In a third step, when detecting that the second user enters into a channel display page including multiple display channels on the intelligent television, other display channels related to the content of the display channel of interest to the second user are pushed to the second user.

To facilitate the second user entering into other display channels related to the content of the display channel of interest to the second user, other display channels related to the content of the display channel of interest to the second user are pushed to the terminal corresponding to the second user, when the channel management platform detects that the second user enters into a channel display page.

Optionally, when browsing to-be-displayed objects on display channels of an intelligent television, the second user may switch between different display channels, or may also switch from a channel display page displaying multiple display channels of the intelligent television to a display channel. The switching from the channel display page to a target display channel includes, but not limited to the following steps.

In a first step, a channel management platform obtains to-be-displayed information corresponding to the target display channel, when detecting that the second user selects the target display channel on the channel display page displayed by the intelligent television.

The channel display page may display the display channels in a form of list. In the embodiment of the present disclosure, when detecting that a display channel is selected, the selected display channel is determined as a target display channel. When detecting that a user selects the target display channel, the channel management platform may determine that the user wants to browse to-be-displayed information which is displayed by the target display channel. Therefore, the channel management platform determines to switch to the target display channel In switching to the target display channel, to-be-displayed information corresponding to the target display channel should be first obtained, to ensure an intelligent television can display the to-be-displayed information of the target display channel.

In a second step, the channel management platform controls the intelligent television to switch from the channel display page to the target display channel, and to display the to-be-displayed information corresponding to the target display channel.

The channel management platform may control the intelligent television to switch from the channel display page to the target display channel by sending switching instructions to the intelligent television. After receiving the switching instructions, the intelligent television is switched from the channel display page to the target display channel. The sending the switching instructions to the intelligent television by the channel management platform may be triggered when the channel management platform detects that the user selects the target display channel.

To facilitate the second user learning about the to-be-displayed information to be displayed on the target display channel, the channel management platform controls the intelligent television to display the to-be-displayed information corresponding to the target display channel, after controlling the intelligent television to switch to the target display channel.

Further, in displaying the to-be-displayed information of the to-be-displayed object by the intelligent television, the second user may be interested in a piece of to-be-displayed information and wants to learn more about content of the piece of to-be-displayed information, which may be achieved via a shopping platform with which the to-be-displayed information is associated. In the embodiment of the present disclosure, to-be-displayed information of interest to the second user which is displayed on the intelligent television is defined as target to-be-displayed information, and the target to-be-displayed information is associated with a designated page of the target shopping platform. On this basis, when selecting the target shopping platform with which the target to-be-displayed information is associated, the second user may turn from a display channel corresponding to the first user to the designated page of the target shopping platform, thereby, learning more about the content of the target display information.

In summary, when detecting that the second user selects the target shopping platform with which the target to-be-displayed information is associated, the channel management platform controls the intelligent television to turn to the designated page of the target shopping platform, and to display information on the designated page.

In this manner, the second user may turn from the display channel corresponding to the first user to the designated page of the target shopping platform, such that the second user obtains more content about the target to-be-displayed information and further completes purchase operations, thereby, facilitating the second user finding out a required article, and extending a promotion range of the to-be-displayed object of the first user.

Optionally, the method according to the embodiment of the present disclosure supports displaying to-be-displayed information of a to-be-displayed object on an intelligent television, a terminal corresponding to the first user may arrange the to-be-displayed information corresponding to a display channel according to the needs of the first user, and the intelligent television supports a function of live broadcast. Therefore, the second user can further watch the procedure that the first user processes the to-be-displayed object, via an intelligent television in a real-time manner. For example, if the second user succeeds in purchasing a to-be-displayed object which is displayed by the intelligent television, and the first user sends the to-be-displayed object which is purchased by the second user to the second user by post, the second user may require the first user to broadcast the process of packaging the to-be-displayed object. For another example, for a to-be-displayed object having a freshness date, to determine a fresh degree of the to-be-displayed object, the second user may require the first user to broadcast in live to see the fresh degree of the to-be-displayed object when being packaged on the intelligent television.

In summary, if the second user wants to watch the procedure of processing the to-be-displayed object on the intelligent television, a processing procedure watching request of the to-be-displayed object may be sent to a terminal corresponding to the first user via a terminal corresponding to the second user. After receiving the processing procedure watching request by the terminal corresponding to the first user, a live video of the to-be-displayed object may be recorded by a device, such as a camera of the terminal corresponding to the second user. Further, in order to meet requirements of watching in a real-time manner for the second user, the terminal corresponding to the first user may generate a video stream of the live video at the current moment based on the live video, and sends the video stream of the live video as the to-be-displayed information of the to-be-displayed object, to the channel management platform. After receiving the video stream of the live video, the channel management platform sends the video stream of the live video to an intelligent television, and controls the intelligent television to broadcast the live video at the current moment. At this time, the second user may watch the live video of the procedure of processing the to-be-displayed object by the first user.

The detailed content of the processing procedure is not limited in the embodiment of the present disclosure. In specific implementations, the processing procedure includes, but not limited to, the live presentation of packaging or using the to-be-processed object which is selected by the second user.

Based on the method according to the embodiment of the present disclosure, a channel management platform associated with an intelligent television is provided. The channel management platform allocates a display channel for a first user and controls the intelligent television to display to-be-displayed information of a to-be-displayed object on the display channels. Therefore, a method for displaying information of a to-be-displayed object corresponding to the first user on an intelligent television is provided, with which a second user can view the information of the to-be-displayed object on the intelligent television, extending an application range of the information display method. In addition, since different first users correspond to different display channels of an intelligent television, a first user can display information on a display channel corresponding to the first user as desired, thereby, enhancing the promotion effect of the to-be-displayed object.

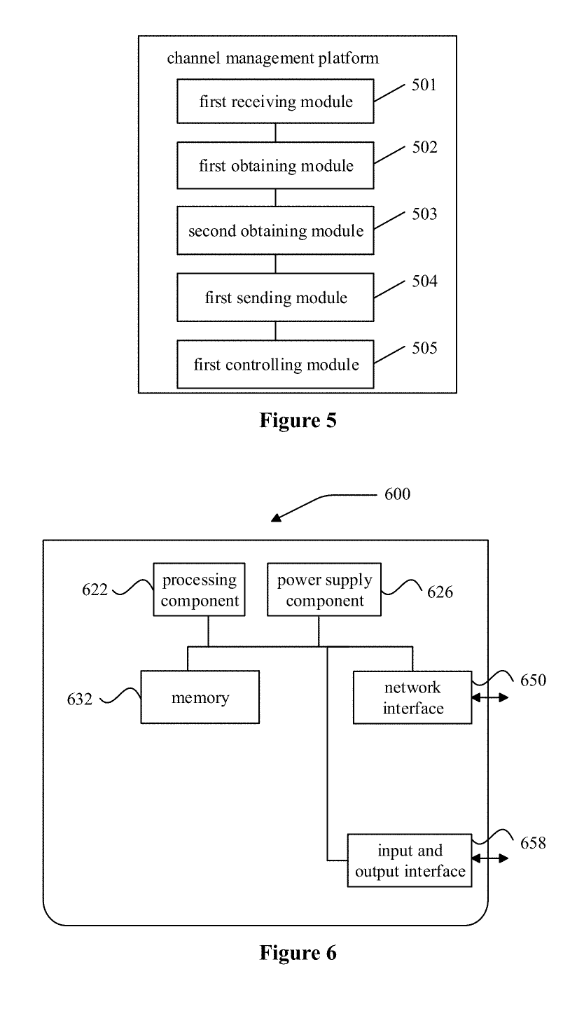

FIG. 5 is a schematic structural diagram of a channel management platform according to an exemplary embodiment. The channel management platform is be configured to execute functions executed by the channel management platform in the above embodiments corresponding to FIG. 2 to FIG. 4. Referring to FIG. 5, the channel management platform includes a first receiving module 501, a first obtaining module 502, a second obtaining module 503, a first sending module 504, and a first controlling module 505.

The first receiving module 501 is configured to receive an information display request and to-be-displayed information of a to-be-displayed object from a terminal corresponding to a first user, where the information display request carries a user identifier, and the to-be-displayed information includes video streams corresponding to the to-be-displayed object at different times.

The first obtaining module 502 is configured to obtain a display channel allocated to the first user in advance based on a user identifier, where the display channel corresponding to the first user is a display channel of the first user on an intelligent television, and different first users correspond to different display channels of the intelligent television.

The second obtaining module 503 is configured to obtain a video stream corresponding to the to-be-displayed object at the current moment from the to-be-displayed information, when detecting that the display channel corresponding to the first user is selected.

The first sending module 504 is configured to send the video stream corresponding to the to-be-displayed object at the current moment to the intelligent television.

The first controlling module 505 is configured to control the intelligent television to broadcast the video stream corresponding to the to-be-displayed object at the current moment on the display channel corresponding to the first user.

In another embodiment, the channel management platform further includes a first determining module and a second controlling module.

The first determining module is configured to determine a category of the display channel corresponding to the first user based on the to-be-displayed information.

The second controlling module is configured to control the intelligent television to display the display channel corresponding to the first user under a corresponding category on a channel display page, when detecting that the intelligent television displays the channel display page.

The channel display page includes at least a pre-set display channel category.

In another embodiment, the channel management platform further includes a counting module, a second determining module, and a third controlling module.

The counting module is configured to count the number of access times of each managed display channel.

The second determining module is configured to determine a popular display channel based on the number of access times of each display channel.

The third controlling module is configured to control the intelligent television to display the popular display channel on a designated region of an information recommendation page, when detecting that the intelligent television displays the information recommendation page.

In another embodiment, the channel management platform further includes a third obtaining module, a third determining module and a pushing module.

The third obtaining module is configured to obtain a history record of each display channel being watched by a second user on the intelligent television.

The third determining module is configured to determine a display channel of interest to the second user, based on the history record of each display channel being watched by the second user on the intelligent television.

The pushing module is configured to push other display channels related to the content of the display channel of interest to the second user to the second user, when detecting that the second user enters into a channel display page including multiple display channels on the intelligent television.

In another embodiment, the channel management platform further includes a second receiving module and a second sending module.

The second receiving module is configured to receive a shopping platform association request from the terminal corresponding to the first user.

The second sending module is configured to send an identifier of a bounded shopping platform to the terminal corresponding to the first user in response to the shopping platform association request, such that the first user associates the to-be-displayed information with a target shopping platform from the bounded shopping platform, based on the identifier of the bounded shopping platform.

In another embodiment, the channel management platform further includes a detecting module and a fourth controlling module.

The detecting module is configured to detect target to-be-displayed information which is selected by the second user from the display channel corresponding to the first user, where the target to-be-displayed information is associated with a designated page of the target shopping platform, and the target shopping platform is one of the bounded shopping platform.

The fourth controlling module is configured to control the intelligent television to turn to the designated page and to display information on the designated page, when detecting that the second user selects the target shopping platform with which the target to-be-displayed information is associated.

Any combinations of all the above optional technical solutions may be used to form an optional embodiment of the present disclosure, which are not repeated herein.

A method for displaying to-be-displayed information of a to-be-displayed object corresponding to a first user on an intelligent television is provided with the described channel management platform controlling the intelligent television to display the to-be-displayed information of the to-be-displayed object on a display channel corresponding to the first user, which extends an application range of the information display method. In addition, since different first users correspond to different display channels of an intelligent television, a first user can display information on a display channel corresponding to the first user as desired, thereby, enhancing the promotion effect of the to-be-displayed object.

FIG. 6 is a schematic structural diagram of a channel management platform according to an exemplary embodiment of the present disclosure. Reference is made FIG. 6. A channel management platform 600 includes a processing component 622 and storage resources represented by a memory 632. The processing component 622 further includes one or more processors. The memory 632 is configured to store instructions executed by the processing component 622, such as application programs. The application programs stored in the memory 632 may include one or more modules, each of which corresponds to a set of instructions. In addition, the processing component 622 is configured to execute the instructions, to execute functions executed by the channel management platform in the information display method according to any of the above embodiments shown in FIG. 2 to FIG. 4.

The channel management platform 600 may further include a power supply component 626 configured to execute power supply management of the channel management platform 600, a wired or wireless network interface 650 configured to connect the channel management platform 600 to a network, and an input/output (I/O) interface 658. The channel management platform 600 may operate an operation system stored in the memory 632, such as Windows Server™, Mac OS X™, Unix™, Linux™, FreeBSD™, or the same.

One or more instructions are stored in the memory and are executed by one or more processors via configuration. The one or more instructions include instructions to perform the following operations:

receiving an information display request and to-be-displayed information of a to-be-displayed object from a terminal corresponding to a first user, where the information display request carries a user identifier, and the to-be-displayed information includes video streams corresponding to the to-be-displayed object at different times;

obtaining, based on the user identifier, a display channel allocated to the first user in advance, where the display channel corresponding to the first user is a display channel of the first user on an intelligent television, and different first users correspond to different display channels of the intelligent television;

obtaining the video stream corresponding to the to-be-displayed object at the current moment from the to-be-displayed information, when detecting that the display channel corresponding to the first user is selected;

sending the video stream corresponding to the to-be-displayed object at the current moment to the intelligent television; and

controlling the intelligent television to broadcast the video stream corresponding to the to-be-displayed object at the current moment on the display channel corresponding to the first user.

Taking the above as a first possible mode of execution, a second possible mode of execution is provided on the basis of the first possible mode of execution. The memory of the channel management platform may further include instructions to perform the following operations after receiving the information display request and the to-be-displayed information of the to-be-displayed object from the terminal corresponding to the first user:
determining a category of the display channel corresponding to the first user based on the to-be-displayed information; and
controlling the intelligent television to display the display channel corresponding to the first user under a corresponding category on a channel display page, when detecting that the intelligent television displays the channel display page, where the channel display page includes at least a pre-set display channel category.

A third possible mode of execution is provided on the basis of the first possible mode of execution. The memory of the channel management platform may further include instructions to perform the following operations:

counting the number of access times of each managed display channel;

determining a popular display channel based on the number of access times of each display channel; and

controlling the intelligent television to display the popular display channel on a designated region of an information recommendation page, when detecting that the intelligent television displays the information recommendation page.

A fourth possible mode of execution is provided on the basis of the first possible mode of execution. The memory of the channel management platform may further include instructions to perform the following operations:

obtaining a history record of each display channel being watched by a second user on the intelligent television;

determining a display channel of interest to the second user, based on the history record of each display channel being watched by the second user on the intelligent television; and

pushing other display channels related to the content of the display channel of interest to the second user to the second user on the intelligent television, when detecting that the second user enters into a channel display page including multiple display channels on the intelligent television.

A fifth possible mode of execution is provided on the basis of the first possible mode of execution. The memory of the channel management platform may further include instructions to perform the following operations:

receiving a shopping platform association request from the terminal corresponding to the first user; and

sending an identifier of a bounded shopping platform to the terminal corresponding to the first user in response to the shopping platform association request, such that the first user associates the to-be-displayed information with a target shopping platform from the bounded shopping platform, based on the identifier of the bounded shopping platform.

A sixth possible mode of execution is provided on the basis of the first possible mode of execution. The memory of the channel management platform may further include instructions to perform the following operations:

detecting target to-be-displayed information which is selected by the second user from the display channel corresponding to the first user, where the target to-be-displayed information is associated with a designated page of the target shopping platform, and the target shopping platform is one of the bounded shopping platform; and

controlling the intelligent television to turn to the designated page and to display information on the designated page, when detecting that the second user selects the target shopping platform with which the target to-be-displayed information is associated.

The channel management platform according to the embodiment of the present disclosure provides a method for displaying to-be-displayed information of a to-be-displayed object corresponding to a first user on an intelligent television, by controlling the intelligent television to display the to-be-displayed information of the to-be-displayed object on a display channel corresponding to the first user, which extends an application range of the information display method. In addition, since different first users correspond to different display channels of an intelligent television, a first user can display information on a display channel corresponding to the first user as desired, thereby, enhancing the promotion effect of the to-be-displayed object.

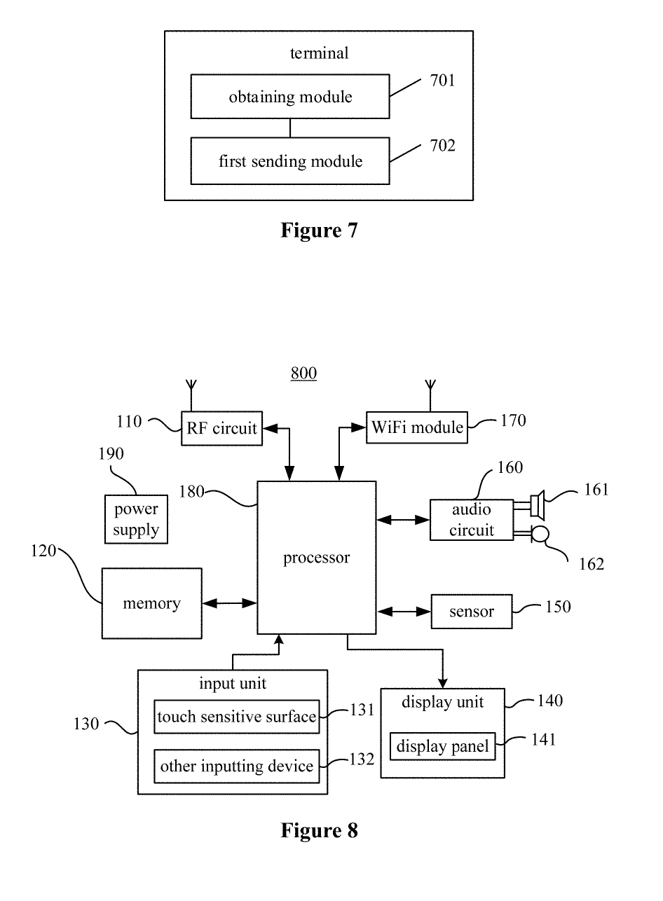

FIG. 7 is a schematic structural diagram of a terminal according to an embodiment of the present disclosure. The terminal may be configured to execute functions executed by the terminal in the information display method according to any of the above embodiments shown in FIG. 2 to FIG. 4. Referring to FIG. 7, the terminal includes a obtaining module 701 and a first sending module 702.

The obtaining module 701 is configured to obtain to-be-displayed information of a to-be-displayed object, where the to-be-displayed information includes video streams corresponding to the to-be-displayed object at different times.

The first sending module 702 is configured to send an information display request and the to-be-displayed information to a channel management platform, such that the channel management platform obtains the video stream corresponding to the to-be-displayed object at the current moment from the to-be-displayed information, when the channel management platform detects that the display channel corresponding to the first user is selected, sends the video stream corresponding to the to-be-displayed object at the current moment to the intelligent television, and controls the intelligent television to broadcast the video stream corresponding to the to-be-displayed object at the current moment on the display channel corresponding to the first user. The information display request carries a user identifier of the first user, the display channel corresponding to the first user is determined by the channel management platform based on the user identifier, and different first users correspond to different display channels of the intelligent television.

In another embodiment, the terminal further includes a second sending module, a first receiving module, a selecting module, and an associating module.

The second sending module is configured to send a shopping platform association request to a channel management platform.

The first receiving module is configured to receive an identifier of a shopping platform bounded to the channel management platform, which is returned by the channel management platform.

The selecting module is configured to select a target shopping platform from the bounded shopping platform based on the identifier of the bounded shopping platform.

The associating module is configured to associate the to-be-displayed information with the target shopping platform.

In another embodiment, the associating module is configured to establish a mapping relation between the to-be-displayed information and detail information of the to-be-displayed object on the target shopping platform, or establish a mapping relation between the to-be-displayed information and a link address of the to-be-displayed object on the target shopping platform.

In another embodiment, the obtaining module includes an obtaining unit, a first generating unit and a second generating unit.

The obtaining unit is configured to obtain a display file of the to-be-displayed object.

The first generating unit is configured to generate a channel timeline of the display files, based on a broadcast time arranged by the first user in advance for each display file, where the channel timeline is used to identify the broadcast time of each display file.

The second generating unit is configured to generate the video streams corresponding to the to-be-displayed object at different times according to the channel timeline and determine the video streams corresponding to the to-be-displayed object at different times as the to-be-displayed information of the to-be-displayed object.

In another embodiment, the terminal further includes a second receiving module, a obtaining module, and a first sending module.

The second receiving module is configured to receive the processing procedure watching request of the to-be-displayed object from the terminal corresponding to the second user.

The obtaining module is configured to record a live video of the to-be-displayed object in response to the processing procedure watching request, generate a video stream of a live video at the current moment based on the live stream, and determine the video stream of the live video as the to-be-displayed information of the to-be-displayed object, where the live video is a video showing that the first user processes the to-be-displayed object.

The first sending module is configured to send the information display request and the video stream of the live video generated in a real-time manner to the channel management platform.

Any combinations of all the above optional technical solutions may be used to form an optional embodiment of the present disclosure, which are not repeated herein.

The terminal according to the embodiment of the present disclosure sends an information display request and to-be-displayed information of a to-be-displayed object to a channel management platform, such that the channel management platform controls an intelligent television to display the to-be-displayed information of the to-be-displayed object on a display channel corresponding to a first user. Therefore, a method for displaying information of a to-be-displayed object corresponding to a first user on an intelligent television is provided, which extends an application range of the information display method. In addition, since different first users correspond to different display channels of an intelligent television, a first user can display information on a display channel corresponding to the first user as desired, thereby, enhancing the promotion effect of the to-be-displayed object.

Reference is made FIG. 8, which is a schematic structural diagram of a terminal according to an embodiment of the present disclosure. The terminal may be configured to implement functions executed by a terminal corresponding to a first user in the information display method according to the above embodiments corresponding to FIG. 2 to FIG. 4.

A terminal 800 may include a RF (Radio Frequency) circuit 110, a memory 120 including one or more computer readable storage media, an inputting unit 130, a display unit 140, a sensor 150, an audio circuit 160, a WiFi (Wireless Fidelity) module 170, a processor 180 including one or more processing cores, and a power supply 190, and so on. It can be understood by those skilled in the art that, the structure of the terminal illustrated in FIG. 8 is not limitation to the terminal. The terminal may include more or less components as compared with the components illustrated in FIG. 8, or have some components combined, or use a different arrangement of the components.

The RF circuit 110 may be configured to receive and send information, or to receive and send signals in a call. Specifically, the RF circuit delivers the downlink information received from a base station to the processor 180 for processing, and transmits designed uplink data to the base station. Generally, the RF circuit 110 includes, but not limited to, an antenna, at least one amplifier, a tuner, one or more oscillators, a subscriber identity module (SIM) card, a transceiver, a coupler, a LNA (Low Noise Amplifier), a duplexer, etc. In addition, the RF circuit 110 may communicate with network and other devices via wireless communication. The wireless communication may use any communication standard or protocol, including, but not limited to, GSM (Global System of Mobile communication), GPRS (General Packet Radio Service), CDMA (Code Division Multiple Access), WCDMA (Wideband Code Division Multiple Access), LTE (Long Term Evolution), E-mail, and SMS (Short Messaging Service).

The memory 120 may be configured to store software programs and modules, and the processor 180 may execute various function applications and data processing by running the software programs and modules stored in the memory 120. The memory 120 may mainly include a program storage area and a data storage area. The program storage area may be used to store, for example, an operating system and an application required by at least one function (for example, a voice playing function, an image playing function). The data storage area may be used to store, for example, data established according to the use of the mobile phone (for example, audio data, or a telephone book). In addition, the memory 120 may include a high-speed random access memory and a nonvolatile memory, such as at least one magnetic disk memory, a flash memory, or other volatile solid-state memory. Correspondingly, the memory 120 may further include a storage controller configured to provide an access to the memory 120 to the processor 180 and the inputting unit 130.

The inputting unit 130 may be configured to receive an inputted number or character information, and generate a signal related to user setting and function controlling, which is inputted with a keyboard, a mouse, an operating rod or a trackball, or an optical input. Specifically, the inputting unit 130 may include a touch sensitive surface 131 and other inputting device 132. The touch sensitive surface 131, also referred to as a touch screen or a touch panel, may collect touch operations of a user which are performed on or near to it (such as operations performed by the user on the touch sensitive surface 131 or near to the touch sensitive surface 131, with a proper object or accessory such as a finger or a stylus), and drive a corresponding connecting device based on a preset program. Optionally, the touch sensitive surface 131 may include a touch detecting device and a touch controlling device. The touch detecting device detects a touch location of the user, detects a signal generated due to an touch operation, and sends the signal to the touch controlling device; the touch controlling device receives touch information from the touch detecting device, converts it into coordinates of a touch point, sends to the processor 180, and receive an instruction from the processor 180 and execute it. In addition, the touch sensitive surface 131 may be resistive, capacitive, infrared or surface acoustic, and so on. In addition to the touch sensitive surface 131, the inputting unit 130 may further include other inputting device 132. Specifically, other inputting device 132 may include, but not limited to, one or more of a physical keyboard, a function button (such as a volume controlling button or a switch button), a trackball, a mouse, an operating rod and so on.

The display unit 140 may be configured to display information inputted by the user or provided for the user, and various graphic user interfaces of the terminal 800. The graphic user interfaces may consist of graphs, text, icons, videos and any combination thereof. The display unit 140 may include a display panel 141. Optionally, the display panel 141 may be configured in a form of LCD (Liquid Crystal Display), or OLED (Organic Light-Emitting Diode) and so on. Furthermore, the touch sensitive surface 131 may cover the display panel 141, and in a case that the touch sensitive surface 131 detects the touch operation on or near to it, it sends the touch operation to the processor 180 to determine a type of a touch event, then the processor 180 provides a corresponding visual output on the display panel 141 based on the type of touch event. In FIG. 8, although the touch sensitive surface 131 and the display panel 141 are illustrated as two individual components to realize an inputting function and an outputting function, the touch sensitive surface 131 and the display panel 141 may be integrated to realize the inputting function and the outputting function in some embodiments.

The terminal 800 may further include the at least one sensor 150, such as a light sensor, a motion sensor and other sensor. Specifically, the light sensor may include an ambient light sensor and a proximity sensor, the ambient light sensor may adjust brightness of the display panel 141 based on brightness of ambient light, and the proximity sensor may close the display panel 141 or backlight in a case that the terminal 800 moves to an ear. As one of motion sensors, a gravity acceleration sensor may detect magnitude of an accelerated rate in each of directions (there are usually three axes), detect magnitude and a direction of gravity while at rest, and be applied to an application which recognize a gesture of the mobile phone (such as switching between portrait and landscape orientation, a related game or magnetometer calibration) and to a function related to vibration recognition (such as a pedometer or a click); and other sensor which may be provided for the terminal 800, such as a gyroscope, a barometer, a hygrometer, a thermometer or an infrared sensor, is not described herein.

The audio circuit 160, a speaker 161 and a microphone 162 may provide an audio interface between the user and the terminal 800. The audio circuit 160 may send a signal, converted from received audio data, to the speaker 161, and then the speaker 161 converts it into an audio signal for outputting; on other hand, the microphone 162 converts a collected audio signal to an electrical signal, the electrical signal is received by the audio circuit 160 and then converted into audio data, and after the audio data is processed by the processor 180, the audio data is sent to another terminal via the RF circuit 110, or the audio data is outputted to the memory 120 for further processing. The audio circuit 160 may further include a headphone jack, so as to provide communications between a peripheral headphone and the terminal 800.

The technology of WiFi belongs to a short-distance wireless transmission technology, the terminal 800 may help the user receive and send emails, browse a webpage, and access to streaming media, with the wireless communication unit 170, and it provides wireless broadband internet access for the user. Although the wireless communication unit 170 is illustrated in FIG. 6, it can be understood that, the wireless communication unit 170 is not a necessary constituent of the terminal 800, and may be omitted based on requirements without changing essence of the present disclosure.

The processor 180 is a control center of the terminal 800, which is connected to each part of the mobile phone with interfaces and circuits, and performs the functions of the terminal 800 and the data processing, by running or executing the software programs or modules stored in the memory 120 and calling data stored in the memory 120, thereby realizing overall monitoring of the mobile phone. Optionally, the processor 180 may include one or more processing cores; preferably, the processor 180 may include an application processor and a modem processor, the application processor is mainly configured to process operating systems, user interfaces and applications, and the modem processor is mainly configured to process wireless communications. It can be understood that the modem processor may not be integrated into the processor 180.

The terminal 800 further includes the power supply 190 (such as a battery) configured to power all the components, Preferably, the power supply may be logically connected with the processor 180 via a power supply management system, so that management of functions such as charging, discharging and power managing, can be realized with the power supply management system. The power supply 190 may further include one or more direct current or alternating current power supplies, a rechargeable system, a power fault detection circuit, a power adapter or inverter, a power status indicator, and so on.

Although not shown in the figure, the terminal 800 may further include a camera, a bluetooth module, and so on, which is not described herein. In specific embodiments, a display unit of a terminal is a touch screen display. The terminal further includes a memory and one or more programs stored in the memory, which are executed by one or more processors via configuration. The one or more programs include instructions to execute the following operations:

obtaining to-be-displayed information of a to-be-displayed object, where the to-be-displayed information includes video streams corresponding to the to-be-displayed object at different times; and

sending an information display request and the to-be-displayed information to a channel management platform, such that the channel management platform obtains the video stream corresponding to the to-be-displayed object at the current moment from the to-be-displayed information when the channel management platform detects that the display channel corresponding to the first user is selected, sends the video stream corresponding to the to-be-displayed object at the current moment to the intelligent television, and controls the intelligent television to broadcast the video stream corresponding to the to-be-displayed object at the current moment on the display channel corresponding to the first user; where

the information display request carries a user identifier of the first user, the display channel corresponding to the first user is determined by the channel management platform based on the user identifier, and different first users correspond to different display channels of the intelligent television.

Taking the above as a first possible mode of execution, a second possible mode of execution is provided on the basis of the first possible mode of execution. The memory of the terminal may further include instructions to execute the following operations after sending an information display request and the to-be-displayed information to a channel management platform:

sending a shopping platform association request to the channel management platform;

receiving an identifier of a shopping platform bounded to the channel management platform, which is returned by the channel management platform;

selecting a target shopping platform from the bounded shopping platform based on the identifier of the bounded shopping platform; and

associating the to-be-displayed information to the target shopping platform.

A third possible mode of execution is provided on the basis of the second possible mode of execution. The memory of the terminal may further include instructions to execute the following operations:

the associating the to-be-displayed information to the target shopping platform including:
establishing a mapping relation between the to-be-displayed information and detail information of the to-be-displayed object on the target shopping platform; or
establishing a mapping relation between the to-be-displayed information and a link address of the to-be-displayed object on the target shopping platform.

A fourth possible mode of execution is provided on the basis of the first possible mode of execution. The memory of the terminal may further include instructions to execute the following operations:

the obtaining the to-be-displayed information of the to-be-displayed object including:
obtaining a display file of the to-be-displayed object;
generating a channel timeline of the display files, based on a broadcast time arranged by the first user in advance for each display file, where the channel timeline is used to identify the broadcast time of each display file; and
generating the video streams corresponding to the to-be-displayed object at different times according to the channel timeline and determining the video streams corresponding to the to-be-displayed object at different times as the to-be-displayed information of the to-be-displayed object.

A fifth possible mode of execution is provided on the basis of the first possible mode of execution. The memory of the terminal may further include instructions to execute the following operations before obtaining the to-be-displayed information of the to-be-displayed object:
receiving the processing procedure watching request of the to-be-displayed object from the terminal corresponding to the second user;

the obtaining the to-be-displayed information of the to-be-displayed object includes:
recording a live video of the to-be-displayed object in response to the processing procedure watching request, where the live video is a video showing that the first user processes the to-be-displayed object; and
generating a video stream of the live video based on the live video and the current moment, and determining the video stream of the live video as the to-be-displayed information of the to-be-displayed object; and

the sending the to-be-displayed information of the to-be-displayed object to the channel management platform includes:
sending the information display request and the video stream of the live video generated in a real-time manner to the channel management platform.

The terminal according to the embodiment of the present disclosure sends an information display request and to-be-displayed information of a to-be-displayed object to a channel management platform, such that the channel management platform controls an intelligent television to display the to-be-displayed information of the to-be-displayed object on a display channel corresponding to a first user. Therefore, a method for displaying information of a to-be-displayed object corresponding to a first user on an intelligent television is provided, which extends an application range of the information display method. In addition, since different first users correspond to different display channels of an intelligent television, a first user can display information on a display channel corresponding to the first user as desired, thereby, enhancing the promotion effect of the to-be-displayed object.

A computer readable storage medium is provided according to embodiment of the present disclosure. The computer readable storage medium may be a computer readable storage medium included in a memory in the above embodiments, or a computer readable storage medium which has not been installed into the terminal. The computer readable storage medium includes one or more programs, which when executed by one or more processors to perform a method for displaying commodity information. The method includes:

obtaining to-be-displayed information of a to-be-displayed object, where the to-be-displayed information includes video streams corresponding to the to-be-displayed object at different times; and

sending an information display request and the to-be-displayed information to a channel management platform, such that the channel management platform obtains the video stream corresponding to the to-be-displayed object at the current moment from the to-be-displayed information when the channel management platform detects that the display channel corresponding to the first user is selected, sends the video stream corresponding to the to-be-displayed object at the current moment to the intelligent television, and controls the intelligent television to broadcast the video stream corresponding to the to-be-displayed object at the current moment on the display channel corresponding to the first user; where

the information display request carries a user identifier of the first user, the display channel corresponding to the first user is determined by the channel management platform based on the user identifier, and different first users correspond to different display channels of the intelligent television.

Taking the above as a first possible mode of execution, a second possible mode of execution is provided on the basis of the first possible mode of execution. The memory of the terminal may further include instructions to execute the following operations after sending an information display request and the to-be-displayed information to a channel management platform:

sending a shopping platform association request to the channel management platform;

receiving an identifier of a shopping platform bounded to the channel management platform, which is returned by the channel management platform;

selecting a target shopping platform from the bounded shopping platform based on the identifier of the bounded shopping platform; and

associating the to-be-displayed information to the target shopping platform.

A third possible mode of execution is provided on the basis of the second possible mode of execution. The memory of the terminal may further include instructions to execute the following operations:

the associating the to-be-displayed information to the target shopping platform including:
establishing a mapping relation between the to-be-displayed information and detail information of the to-be-displayed object on the target shopping platform; or
establishing a mapping relation between the to-be-displayed information and a link address of the to-be-displayed object on the target shopping platform.

A fourth possible mode of execution is provided on the basis of the first possible mode of execution. The memory of the terminal may further include instructions to execute the following operations:

the obtaining the to-be-displayed information of the to-be-displayed object including:
obtaining a display file of the to-be-displayed object;
generating a channel timeline of the display files, based on a broadcast time arranged by the first user in advance for each display file, where the channel timeline is used to identify the broadcast time of each display file; and
generating the video streams corresponding to the to-be-displayed object at different times according to the channel timeline and determining the video streams corresponding to the to-be-displayed object at different times as the to-be-displayed information of the to-be-displayed object.

A fifth possible mode of execution is provided on the basis of the first possible mode of execution. The memory of the terminal may further include instructions to execute the following operations before obtaining the to-be-displayed information of the to-be-displayed object:
receiving the processing procedure watching request of the to-be-displayed object from the terminal corresponding to the second user;

the obtaining the to-be-displayed information of the to-be-displayed object including:
recording a live video of the to-be-displayed object in response to the processing procedure watching request, generate a video stream of a live video at the current moment based on the live stream; and
determining the video stream of the live video as the to-be-displayed information of the to-be-displayed object, where the live video is a video showing that the first user processes the to-be-displayed object; and

the sending the to-be-displayed information of the to-be-displayed object to the channel management platform including:
sending the information display request and the video stream of the live video generated in a real-time manner to the channel management platform.

Based on the computer readable storage medium according to the embodiment of the present disclosure, the information display request and the to-be-displayed information of the to-be-displayed object are sent to a channel management platform, such that the channel management platform controls an intelligent television to display to-be-displayed information of a to-be-displayed object on a display channel corresponding to a first user. Therefore, a method for displaying information of a to-be-displayed object corresponding to a first user on an intelligent television is provided, which extends an application range of the information display method. In addition, since different first users correspond to different display channels of an intelligent television, a first user can display information on a display channel corresponding to the first user as desired, thereby, enhancing the promotion effect of the to-be-displayed object.

A graphical user interface is provided according to an embodiment of the present disclosure. The graphical user interface is applied to a terminal. The terminal includes a touch screen display, a memory and one or more processors configured to execute one or more programs. The graphical user interface includes:

obtaining to-be-displayed information of a to-be-displayed object, where the to-be-displayed information includes video streams corresponding to the to-be-displayed object at different times; and

sending an information display request and the to-be-displayed information to a channel management platform, such that the channel management platform obtains the video stream corresponding to the to-be-displayed object at the current moment from the to-be-displayed information, when the channel management platform detects that the display channel corresponding to the first user is selected, sends the video stream corresponding to the to-be-displayed object at the current moment to the intelligent television, and controls the intelligent television to broadcast the video stream corresponding to the to-be-displayed object at the current moment on the display channel corresponding to the first user; where

the information display request carries a user identifier of the first user, the display channel corresponding to the first user is determined by the channel management platform based on the user identifier, and different first users correspond to different display channels of the intelligent television.

Based on the graphical user interface according to the embodiment of the present disclosure, the information display request and the to-be-displayed information of the to-be-displayed object are sent to the channel management platform, such that the channel management platform controls an intelligent television to display to-be-displayed information of a to-be-displayed object on a display channel corresponding to a first user. Therefore, a method for displaying information of a to-be-displayed object corresponding to a first user on an intelligent television is provided, which extends an application range of the information display method. In addition, since different first users correspond to different display channels of an intelligent television, a first user can display information on a display channel corresponding to the first user as desired, thereby, enhancing the promotion effect of the to-be-displayed object.

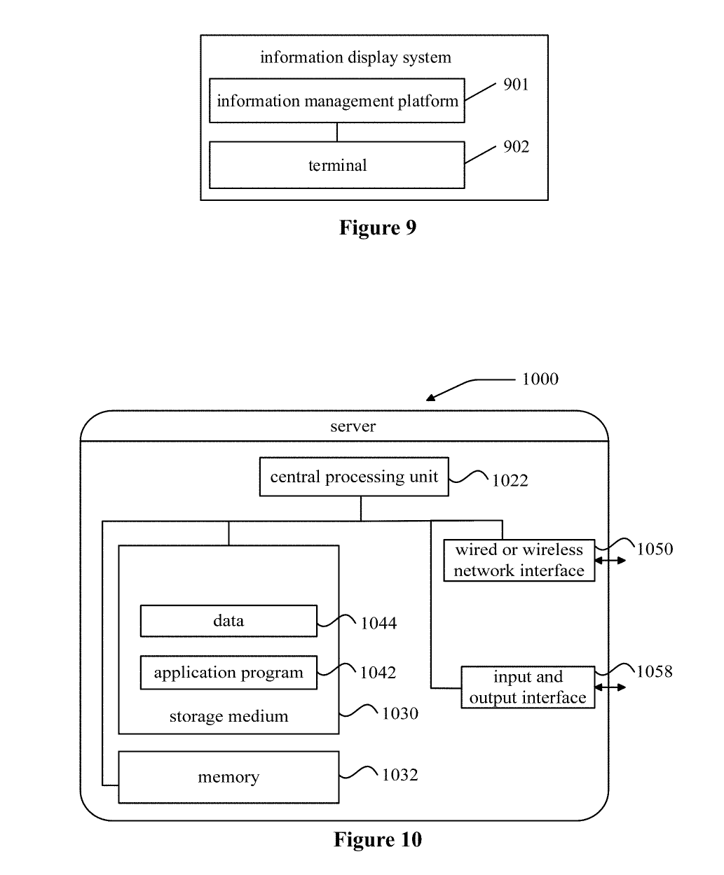

FIG. 9 is a schematic structural diagram of an information display system according to an exemplary embodiment. As shown in FIG. 9, the information display system includes a channel management platform 901 and a terminal 902.

The channel management platform 901 is the channel management platform according to the above embodiments corresponding to FIG. 5 or FIG. 6. For the details of the channel management platform, reference may be made to the above embodiments corresponding to FIG. 5 or FIG. 6, which are not repeated herein.

The terminal 902 is the terminal according to the above embodiments corresponding to FIG. 7 or FIG. 8. For the details of the terminal, reference may be made to content in the above embodiments corresponding to FIG. 7 or FIG. 8, which are not repeated herein.

Based on the system according to the embodiment of the present disclosure, an information display request and the to-be-displayed information of the to-be-displayed object are sent to a channel management platform, such that the channel management platform controls an intelligent television to display to-be-displayed information of a to-be-displayed object on a display channel corresponding to a first user. Therefore, a method for displaying information of a to-be-displayed object corresponding to a first user on an intelligent television is provided, which extends an application range of the information display method. In addition, since different first users correspond to different display channels of an intelligent television, a first user can display information on a display channel corresponding to the first user as desired, thereby, enhancing the promotion effect of the to-be-displayed object.

FIG. 10 is a schematic structural diagram of a channel management platform according to an embodiment of the present disclosure. The channel management platform 1000 may have different configurations or performances, and may include one or more central processing units (CPU) 1022 (such as one or more processors), a memory 1032, and a storage medium 1030 (such as one or more mass storage devices) storing one or more storage application programs 1042 or data 1044. The memory 1032 and the storage medium 1030 may be a temporary or permanent storage. The program stored in the storage medium 1030 may include one or more modules (not shown in the figure), each of which may include a series of instruction operations on a channel management platform. Further, the central processor 1022 may be configured to communicate with the storage medium 1030, and to perform a series of instruction operations in the storage medium 1030 on the channel management platform 1000.

The channel management platform 1000 may also include one or more wired or wireless network interfaces 1050, one or more input and output interfaces 1058, and the like.

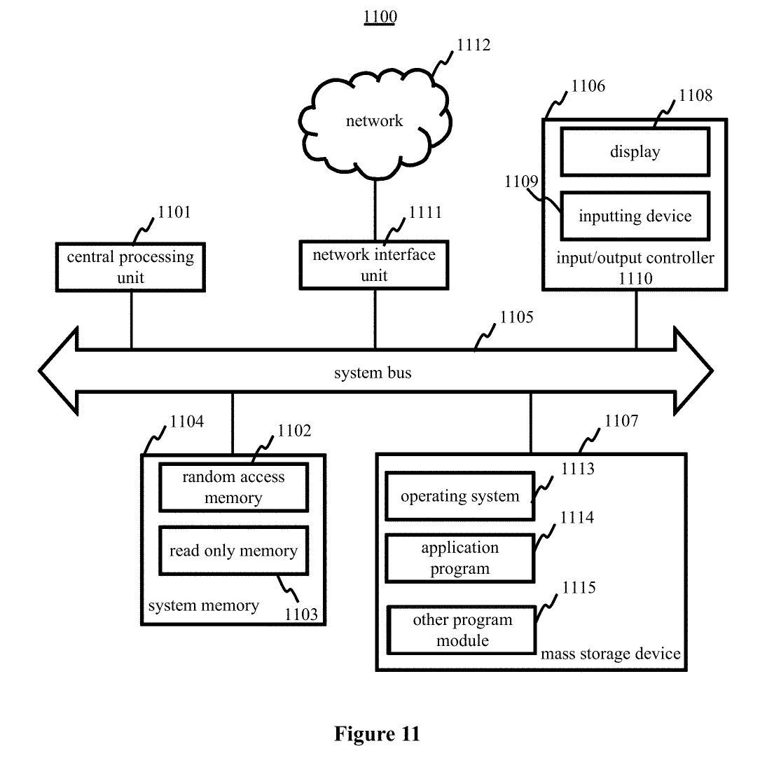

FIG. 11 is a schematic structural diagram of a channel management platform according to an embodiment of the present disclosure. The channel management platform is configured to implement the information display method according to the above embodiments.

The channel management platform 1100 includes a central processing unit (CPU) 1101, a system memory 1104 including a random access memory (RAM) 1102 and a read only memory (ROM) 1103, and a system bus 1105 connected to the system memory 1104 and the central processing unit 1101. The channel management platform 1100 further includes a basic input/output system (I/O system) 1106 assisting in transmitting information among various devices inside the computer, and a mass storage device 1107 configured to store an operating system 1113, an application program 1114 and other program module 1115.

The basic input/output system 1106 includes a display 1108 configured to display information and an inputting device 1109, such as a mouse, a keyboard, or the like, configured to input information by a user. Both the display 1108 and the inputting device 1109 are connected to the central processing unit 1101 via an input and output controller 1110 connected to the system bus 1105. The basic input/output system 1106 may also include the input and output controller 1110 configured to receive and process input from multiple other devices, such as a keyboard, a mouse, or an electronic stylus. Similarly, the input and output controller 1110 further provides output to a display screen, a printer, or other types of outputting devices.

The mass storage device 1107 is connected to the central processing unit 1101 via a mass storage controller (not shown) connected to the system bus 1105. The mass storage device 1107 and its associated computer readable media provide non-volatile storage for the channel management platform 1100. That is, the mass storage device 1107 may include a computer readable medium (not shown), such as a hard disk or a CD-ROM drive.

Without loss of generality, the computer readable medium may include a computer storage medium and a communication medium. The computer storage medium includes volatile and nonvolatile, removable and non-removable media implemented with any method or technology for storing information, such as computer readable instructions, data structures, program modules, or other data. The computer storage medium includes solid state storages such as RAM, ROM, EPROM, EEPROM, flash memory or other solid state storage technology, optical storages such as CD-ROM, DVD, or the like, and magnetic storage devices such as magnetic tape, magnetic disk storage or the like. As recognized by those skilled in the art, the computer storage medium is not limited to the above. The above system memory 1104 and the mass storage device 1107 may be collectively referred to as a memory.

According to various embodiments of the present disclosure, the channel management platform 1100 may further be connected to a remote computer over a network, such as the Internet, for operating. That is, the channel management platform 1100 may be connected to the network 1112 via a network interface unit 1111 connected to the system bus 1105, or, may be connected to other types of networks or remote computer systems (not shown in the figure) via the network interface unit 1111.

The memory further includes one or more programs, which is stored in a memory and configured to be executed by one or more processors. The one or more programs include instructions to execute the information display method on the channel management platform side according to any of the above embodiments.

It should be noted that, the channel management platform and the terminal according to the above embodiments for performing the information display method are described only by taking the division of the above various functional modules as an example. In practical applications, the above functions may be implemented by configuring the functions to different functional modules, that is, the internal structure of a device is divided into different functional modules to perform the above all or part of the functions. In addition, the channel management platform and the terminal according to the embodiments belong to a same concept as the embodiments of the information display method, and for the detailed implementations thereof, reference may be made to the embodiments of the method, which are not repeated herein.

It may be understood by those skilled in the art, all or part of steps of the above-described embodiments may be implemented in hardware, may also be implemented in programs instructing the hardware. The program may be stored in a computer readable storage medium. The above-mentioned storage medium may be a read-only memory, a disk or a CD etc.

While the above describes some embodiments of the present disclosure, the protection scope of the present disclosure is not limited to these embodiments. Therefore, any modifications, equivalents and improvements within the spirit and the principles of the present disclosure are fall within the protection scope of the present disclosure.

1. An information display method applied in a channel management platform having a processor and a memory, the information display method comprising:
receiving an information display request and to-be-displayed information of a to-be-displayed object from a terminal corresponding to a first user, wherein the information display request includes a user identifier, and the to-be-displayed information comprises video streams corresponding to the to-be-displayed object at different times;
obtaining, based on the user identifier, a display channel allocated to the first user in advance, wherein the display channel corresponding to the first user is a display channel of the first user on an intelligent television, and wherein different first users correspond to different display channels of the intelligent television;
obtaining the video stream corresponding to the to-be-displayed object at a current moment from the to-be-displayed information, when detecting that the display channel corresponding to the first user is selected;
sending the video stream corresponding to the to-be-displayed object at the current moment to the intelligent television; and
controlling the intelligent television to broadcast the video stream corresponding to the to-be-displayed object at the current moment on the display channel corresponding to the first user.

2. The method according to claim 1, wherein after receiving the information display request and the to-be-displayed information of the to-be-displayed object from the terminal corresponding to the first user, the method further comprises:
determining a category of the display channel corresponding to the first user based on the to-be-displayed information; and
controlling the intelligent television to display the display channel corresponding to the first user under a corresponding category on a channel display page, when detecting that the intelligent television displays the channel display page, wherein the channel display page comprises at least a pre-set display channel category.

3. The method according to claim 1, further comprising:
counting the number of access times of each managed display channel;
determining a popular display channel based on the number of access times of each display channel; and
controlling the intelligent television to display the popular display channel on a designated region of an information recommendation page, when detecting that the intelligent television displays the information recommendation page.

4. The method according to claim 1, further comprising:
obtaining a history record of each display channel being watched by a second user on the intelligent television;
determining a display channel of interest to the second user, based on the history record of each display channel being watched by the second user on the intelligent television; and
pushing other display channels related to the content of the display channel of interest to the second user on the intelligent television, when detecting that the second user enters into a channel display page comprising multiple display channels on the intelligent television.

5. The method according to claim 1, wherein after receiving the information display request and the to-be-displayed information of the to-be-displayed object from the terminal corresponding to the first user, the method further comprises:
receiving a shopping platform association request from the terminal corresponding to the first user;
sending an identifier of a bounded shopping platform to the terminal corresponding to the first user in response to the shopping platform association request, wherein the first user associates the to-be-displayed information with a target shopping platform from the bounded shopping platform, based on the identifier of the bounded shopping platform.

6. The method according to claim 1, wherein after controlling the intelligent television to broadcast the video stream corresponding to the to-be-displayed object at the current moment on the display channel corresponding to the first user, the method further comprises:
detecting target to-be-displayed information which is selected by the second user from the display channel corresponding to the first user, wherein the target to-be-displayed information is associated with a designated page of the target shopping platform, and the target shopping platform is one of the bounded shopping platform; and
controlling the intelligent television to turn to the designated page and display information on the designated page, when detecting that the second user selects the target shopping platform with which the target to-be-displayed information is associated.

7. An information display method applied in a terminal having a processor and a memory, the information display method comprising:
obtaining to-be-displayed information of a to-be-displayed object, wherein the to-be-displayed information comprises video streams corresponding to the to-be-displayed object at different times; and
sending an information display request and the to-be-displayed information to a channel management platform, wherein the channel management platform obtains the video stream corresponding to the to-be-displayed object at a current moment from the to-be-displayed information when the channel management platform detects that the display channel corresponding to the first user is selected, sends the video stream corresponding to the to-be-displayed object at the current moment to the intelligent television, and controls the intelligent television to broadcast the video stream corresponding to the to-be-displayed object at the current moment on the display channel corresponding to the first user; wherein
the information display request includes a user identifier of the first user, the display channel corresponding to the first user is determined by the channel management platform based on the user identifier, and different first users corresponding to different display channels of the intelligent television.

8. The method according to claim 7, wherein after sending the information display request and the to-be-displayed information to the channel management platform, the method further comprises:
sending a shopping platform association request to the channel management platform;
receiving an identifier of a shopping platform bounded to the channel management platform, which is returned by the channel management platform;
selecting a target shopping platform from the bounded shopping platform based on the identifier of the bounded shopping platform; and
associating the to-be-displayed information to the target shopping platform.

9. The method according to claim 8, wherein the associating the to-be-displayed information to the target shopping platform comprises:
establishing a mapping relation between the to-be-displayed information and detail information of the to-be-displayed object on the target shopping platform; or
establishing a mapping relation between the to-be-displayed information and a link address of the to-be-displayed object on the target shopping platform.

10. The method according to claim 7, wherein the obtaining the to-be-displayed information of the to-be-displayed object comprises:
obtaining a display file of the to-be-displayed object;
generating a channel timeline based on a broadcast time arranged by the first user in advance for each display file, wherein the channel timeline is used to identify the broadcast time of each display file; and
generating the video streams corresponding to the to-be-displayed object at different times according to the channel timeline and determining the video streams corresponding to the to-be-displayed object at different times as the to-be-displayed information of the to-be-displayed object.

11. The method according to claim 7, wherein before obtaining the to-be-displayed information of the to-be-displayed object, the method comprises:
receiving a processing procedure watching request of the to-be-displayed object from a terminal corresponding to a second user;
the obtaining the to-be-displayed information of the to-be-displayed object comprises:
recording a live video of the to-be-displayed object in response to the processing procedure watching request, wherein the live video is a video showing that the first user processes the to-be-displayed object; and
generating a video stream of the live video based on the live video and the current moment, and determining the video stream of the live video as the to-be-displayed information of the to-be-displayed object; and
the sending the information display request and the to-be-displayed information to the channel management platform comprises:
sending the information display request and the video stream of the live video generated in a real-time manner to the channel management platform.

12. A channel management platform, comprising a processor and a memory, wherein the memory stores a set of program codes, and the processor is configured to execute the program codes stored in the memory to perform the following operations:
receiving an information display request and to-be-displayed information of a to-be-displayed object from a terminal corresponding to a first user, wherein the information display request carries a user identifier, and the to-be-displayed information comprises video streams corresponding to the to-be-displayed object at different times;
obtaining, based on the user identifier, a display channel allocated to the first user in advance, wherein the display channel corresponding to the first user is a display channel of the first user on an intelligent television, and wherein different first users correspond to different display channels of the intelligent television;
obtaining the video stream corresponding to the to-be-displayed object at a current moment from the to-be-displayed information, when detecting that the display channel corresponding to the first user is selected;
sending the video stream corresponding to the to-be-displayed object at the current moment to the intelligent television; and
controlling the intelligent television to broadcast the video stream corresponding to the to-be-displayed object at the current moment on the display channel corresponding to the first user.

13. The channel management platform according to claim 12, wherein the processor is further configured to execute the program codes stored in the memory to perform the following operations:
determining a category of the display channel corresponding to the first user based on the to-be-displayed information; and
controlling the intelligent television to display the display channel corresponding to the first user under a corresponding category on a channel display page, when detecting that the intelligent television displays the channel display page, wherein
the channel display page comprises at least a pre-set display channel category.

14. The channel management platform according to claim 12, wherein the processor is further configured to execute the program codes stored in the memory to perform the following operations:
counting the number of access times of each managed display channel;
determining a popular display channel based on the number of access times of each display channel; and
controlling the intelligent television to display the popular display channel on a designated region of an information recommendation page, when detecting that the intelligent television displays the information recommendation page.

15. The channel management platform according to claim 12, wherein the processor is further configured to execute the program codes stored in the memory to perform the following operations:
obtaining a history record of each display channel being watched by a second user on the intelligent television;
determining a display channel of interest to the second user, based on the history record of each display channel being watched by the second user on the intelligent television; and
pushing other display channels related to the content of the display channel of interest to the second user on the intelligent television, when detecting that the second user enters into a channel display page comprising multiple display channels on the intelligent television.

16. The channel management platform according to claim 12, wherein the processor is further configured to execute the program codes stored in the memory to perform the following operations:
receiving a shopping platform association request from the terminal corresponding to the first user; and
sending an identifier of a bounded shopping platform to the terminal corresponding to the first user in response to the shopping platform association request, wherein the first user associates the to-be-displayed information with a target shopping platform from the bounded shopping platform, based on the identifier of the bounded shopping platform.

17. The channel management platform according to claim 12, wherein the processor is further configured to execute the program codes stored in the memory to perform the following operations:
detecting target to-be-displayed information which is selected by the second user from the display channel corresponding to the first user, wherein the target to-be-displayed information is associated with a designated page of the target shopping platform, and the target shopping platform is one of the bounded shopping platform; and
controlling the intelligent television to turn to the designated page and display information on the designated page, when detecting that the second user selects the target shopping platform with which the target to-be-displayed information is associated.
